(19) United States
(12) Patent Application Publication
(10) Pub. No.: US 2007/0024223 A1
(43) Pub. Date: Feb. 1, 2007

(54) Start-up circuit for DC fan

(75) Inventors: Yong-Xing You, Shenzhen (CN); Feng-Long He, Shenzhen (CN); Hai-Qing Zhou, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Ty-Cheng City (TW)

(21) Appl. No.: 11/440,284

(22) Filed: May 24, 2006

(30) Foreign Application Priority Data
Jul. 29, 2005 (CN) 200510036289.3

(51) Int. Cl. H02P 1/00; H02P 7/00

(52) U.S. Cl. 318/272

(57) ABSTRACT

A start-up circuit which decreases a start-up current and stabilizes running of a DC fan. The start-up circuit includes a digital-analog converter for convert a digital control signal from a control chip to an analog control signal, a comparator, a switching device for controlling start-up of the DC fan, and a feedback device adjusting current passing through the switching device. The comparator includes two input terminals and an output terminal. One input terminal is connected to an output terminal of the digital-analog converter. The switching device is connected to the output terminal of the comparator. An output signal of the switching device is inputted to the other input terminal of the comparator via the feedback device.

### CROSS-REFERENCES TO RELATED APPLICATION

Relevant subject matter is disclosed in the copending U.S. patent application Ser. No. 11/247,343, filed on Oct. 11, 2005, and entitled “START-UP CIRCUIT FOR DC FAN,” which is assigned to the same assignee with this patent application.

### BACKGROUND OF THE INVENTION

1. Field of the Invention

The present invention relates to a start-up circuit for a direct current (DC) fan, and particularly to a start-up circuit which has a decreased start-up current and which stabilizes running of a DC fan.

2. General Background

Developments in today's highly information-intensive society have led to remarkable improvements in performances of electronic devices. During operation of many contemporary electronic devices such as central processing units (CPUs), large amounts of heat are produced. Typically, an electric fan is used to facilitate removal of the heat. The fan must run stably, so as to prevent the device from becoming unstable or being damaged. A start-up circuit accompanying the fan is quite important to ensure normal running of the fan.

FIG. 3 shows a conventional start-up circuit of a DC fan. A Pulse-Width Modulation (PWM) signal from a control chip directly drives transistors Q70 and Q100. The transistors Q70 and Q100 directly drive a DC fan. A high capacity electrolytic capacitor C63 is provided for wave filtering. When the start-up circuit is started, a large start-up current is generated at that instant. The start-up current is liable to damage or even ruin the transistors Q70 and Q100. In addition, although the high capacity electrolytic capacitor C63 is employed, voltage ripples may still occur. When this happens, the fan may rotate unstably.

FIG. 4 represents a start-up voltage control circuit of a DC brushless fan, as disclosed in Taiwan Patent Application No. 092215559. The control circuit includes a comparator 1, a voltage sampling circuit 2, and an on-off control circuit 3. The comparator 1 compares a supply voltage of a supply circuit with a reference voltage that meets with a fan driving voltage specification. The on-off control circuit 3 is connected to an output terminal of the comparator 1, for controlling whether a drive circuit 4 and a fan motor 6 are connected to the supply circuit. The on-off control circuit 3 includes transistors Q1 and Q2. However, the transistors Q1 and Q2 are directly controlled by the supply circuit. When a starting current passing through the transistors Q1 and Q2 is too large, the transistors Q1 and Q2 are liable to be damaged or even ruined.

What is needed is a start-up circuit which has a decreased start-up current and which can stably run a DC fan.

### SUMMARY

A start-up circuit of a DC fan in accordance with a preferred embodiment includes a digital-analog converter for convert a digital control signal from a control chip to an analog control signal, a comparator as a voltage stabilizer, a switching device for controlling start-up of the DC fan, and a feedback device adjusting current passing through the switching device. The comparator includes two input terminals and an output terminal. One input terminal is connected to an output terminal of the digital-analog converter. The switching device is connected to the output terminal of the comparator. An output signal of the switching device is inputted to the other input terminal of the comparator via the feedback device.

The digital-analog converter of the star-up circuit converts the digital control signal to the smooth analog control signal to get a linear drive. The linear drive makes working voltage of the DC fan to be zero ripples, which makes the DC fan to rotate evenly and has lower noise. Rotation speed of the DC fan and the PWM control signal are in direct proportion, to prevent a too-low rotation speed and cease of the DC fan. The digital-analog converter also used for preventing a large current in a power turn-on instant. The feedback device lowers the current passing through the switching device when the current is too high, therefore the keeping a constant current to even the rotation speed.

Other advantages and novel features will become more apparent from the following detailed description, in which:

### BRIEF DESCRIPTION OF THE DRAWINGS

FIG. 1 is a system block diagram of a start-up circuit for a DC fan in accordance with embodiment of the present invention;

FIG. 2 is a circuit diagram of a start-up circuit for a DC fan in accordance with the preferred embodiment of the present invention;

FIG. 3 is a circuit diagram of a conventional start-up circuit for a DC fan; and

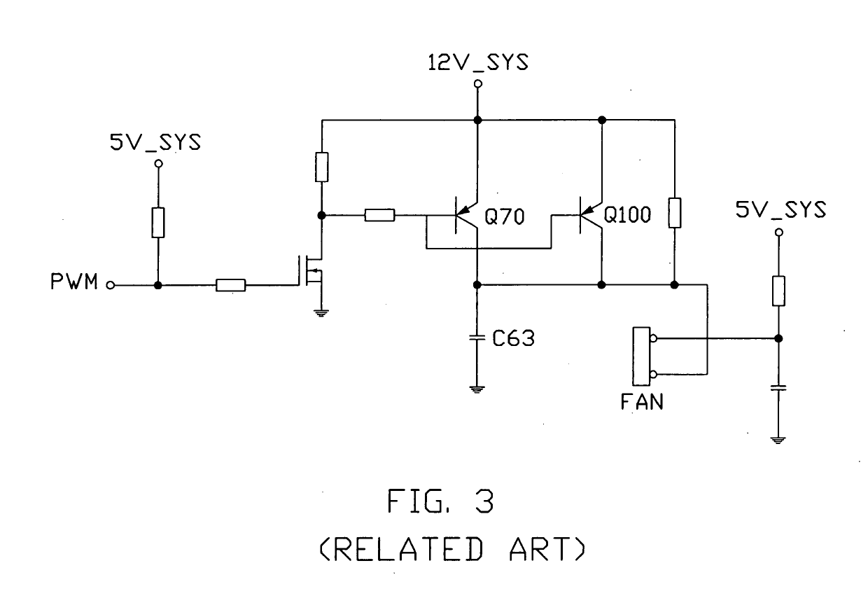

FIG. 4 is a circuit diagram of another conventional circuit for a DC fan.

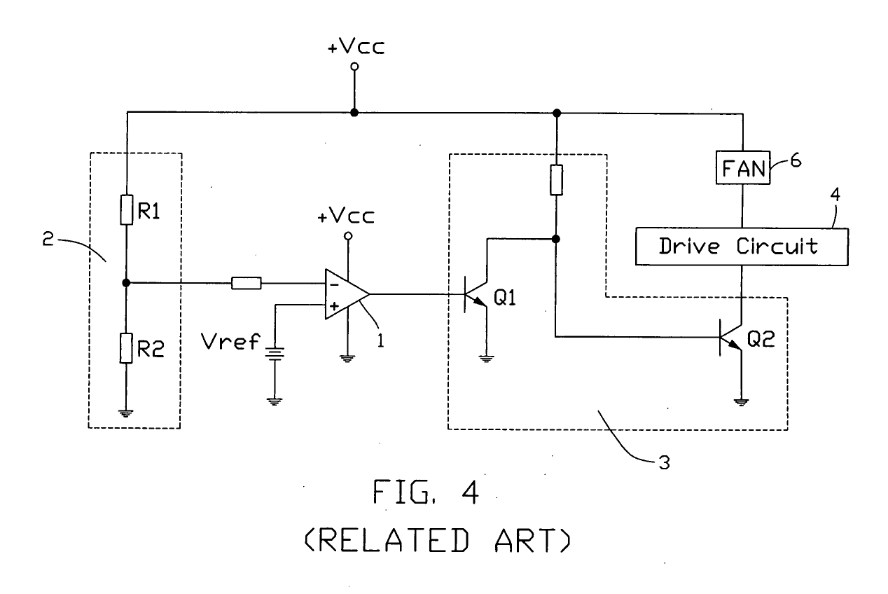

### DETAILED DESCRIPTION OF THE EMBODIMENTS

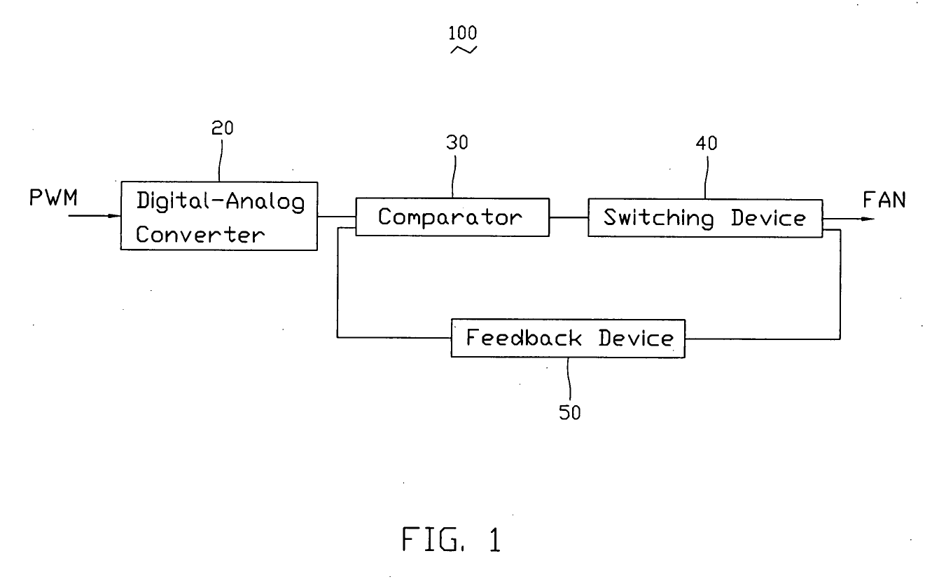

Referring to FIG. 1, a system block diagram of a start-up circuit 100 for a functional component like a DC fan in accordance with embodiment of the present invention is shown. A pulse width modulation (PWM) digital control signal comes from a control chip such as a Super I/O chip (not shown). The PWM digital control signal has a fixed frequency. The start-up circuit 100 includes a digital-analog converter 20, a comparator 30 as a voltage stabilizer, and a switching device 40, which are connected in series. The digital-analog converter 20 converts the PWM digital control signal to a smooth analog control signal. The analog control signal is inputted to an input terminal of the comparator 30. An output terminal of the comparator 30 is connected to the switching device 40, to drive the switching device 40 to control current passing through the DC fan. The start-up circuit 100 further includes a feedback device 50 to control the current passing through the switching device 40. An output signal of the switching device 40 is inputted to another input terminal of the comparator 30 via the feedback device 50.

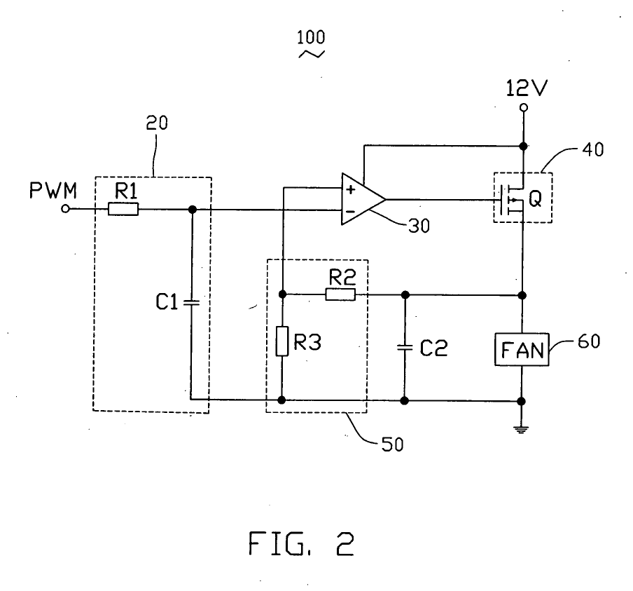

Referring also to FIG. 2, this shows the start-up circuit 100 connected with a DC fan 60, in accordance with the preferred embodiment of the present invention. The digital-analog converter 20 includes an integral circuit that is composed of a first resistor R1 and a first capacitor C1 connected in series. An input terminal of the first resistor R1 receives the PWM digital control signal of the control chip, an output terminal of the first resistor R1 is connected to one end of the first capacitor C1, and the other end of the first capacitor C1 is grounded. The switching device 40 includes a P-channel enhancement mode Metal-Oxide Semiconductor Field Effect Transistor (MOSFET) Q. The MOSFET Q has a gate, a drain, and a source. The gate of the MOSFET Q is connected to an output terminal of the comparator 30. The source of the MOSFET Q is connected to the DC fan 60. The drain of the MOSFET Q is connected to a supply voltage 12V as a power source thereof. The feedback device 50 includes a second resistor R2 and a third resistor R3 connected in series providing series negative feedback. Resistances of the second resistor R2 and the third resistor R3 are configured to feed a suitable voltage to the DC fan 60 according to specifications of the DC fan 60. A node between respective ends of the second resistor R2 and the third resistor R3 is connected to a non-inverting input terminal of the comparator 30. The other end of the second resistor R2 is connected to a node between the source of the MOSFET Q and the DC fan 60. The other end of the third resistor R3 is grounded. One end of a second capacitor C2 is connected to the other end of the second resistor R2, and the other end of the second capacitor C2 is grounded. The second capacitor C2 is used for filtering a voltage of the DC fan 60. The source of the MOSFET Q outputs signals to an non-inverting input terminal of the comparator 30 via the feedback device 50.

At the instant power is turned on, the first capacitor C1 begins to charge, and a voltage of the inverting input terminal of the comparator 30 rises from zero volts. Before the voltage rises from an inverting input voltage to a non-inverting input voltage, an output voltage of the comparator 30 is very high. Current passing through the MOSFET Q is very low, so the MOSFET Q is turned off. The MOSFET Q is thereby protected at the instant of power turn-on. As the charge of the first capacitor C1 increases, the inverting input voltage of the comparator 30 increases and finally exceeds the non-inverting input voltage of the comparator 30. The MOSFET Q is thus turned on, and drives the DC fan 60 to work. As the output voltage of the comparator 30 decreases, a gate voltage of the MOSFET Q decreases. Accordingly, a source current of the MOSFET Q increases, so as to increase a current of the DC fan 60. Because of the feedback device 50, when the source current of the MOSFET Q increases, the non-inverting input voltage of the comparator 30 increases. Accordingly, the output voltage of the comparator 40 increases. As a result, the gate voltage of the MOSFET Q increases, the source current of the MOSFET Q decreases, and the current of the DC fan 60 decreases. Therefore, the current of the DC fan 60 is kept stable, so that the DC fan 60 rotates smoothly.

In the working procedure of the start-up circuit 100, when the PWM digital control signal having an amplitude Vamp and a duty cycle D is applied to the digital-analog converter 20, a voltage Vc₁ of the first capacitor C1 is:
Vc₁=Vamp*D (1)

When the voltage Vc₁ is applied to the comparator 30, the non-inverting input voltage V+ is:

$$V += Vfan * \frac{R 3}{R 2 + R 3} = Vamp * D = V - \qquad ( 2 )$$

Wherein, Vfan is a voltage of the DC fan 60.

Then, The voltage Vfan of the DC fan 60 is:

$$Vfan = \frac{Vamp * D * ( R 3 + R 2 )}{R 3} \qquad ( 3 )$$

It can be deduced from formula (3) that the amplitude Vamp, the second resistor R2, and the third resistor R3 are constant. The voltage Vfan of the DC fan 60 and the duty cycle D of the PWM digital control signal are in a linear relationship. That is, the rotation speed of the DC fan 60 is in direct proportion to the duty cycle D of the PWM digital control signal.

In other words, the start-up circuit 100 is linearly driven. In the range of 0˜100% of the duty cycle D of the PWM digital control signal, the fan voltage Vfan is changed smoothly.

The switching device 40 of the start-up circuit 100 also includes a Bipolar Junction Transistor (BJT) in the preferred embodiment, and function of the start-up circuit 100 with the BJT insteading of the MOSFET Q is similar to the start-up circuit 100 of the preferred embodiment.

It is believed that the present embodiments and their advantages will be understood from the above description, and various changes may be made thereto without departing from the spirit and scope of the invention or sacrificing all of its material advantages, the examples described merely being preferred or exemplary embodiments.

We claim:

1. A start-up circuit for a direct current (DC) fan, comprising:
a digital-analog converter for converting a digital control signal of a control chip to an analog control signal, the digital-analog converter comprising an output terminal;
a comparator comprising two input terminals and an output terminal, one of the input terminals being connected to the output terminal of the digital-analog converter;
a switching device for controlling start-up of the DC fan, the switching device being connected to the output terminal of the comparator; and
a feedback device for adjusting a current passing through the switching device, an output signal of the switching device being inputted to the other one of the input terminals of the comparator via the feedback device.

2. The start-up circuit as claimed in claim 1, wherein the digital-analog converter comprises an integral circuit that has a first resistor and a first capacitor connected in series, an input terminal of the first resistor receives the digital control signal of the control chip, an output terminal of the first resistor is connected to one end of the first capacitor and acting as the output terminal of the digital-analog converter, and the other end of the first capacitor is grounded.

3. The start-up circuit as claimed in claim 2, wherein the first capacitor also prevents a large current flow at the instant of power turn-on of the start-up circuit.

4. The start-up circuit as claimed in claim 1, wherein the switching device comprises a P-channel enhancement mode Metal-Oxide Semiconductor Field Effect Transistor (MOSFET), and the MOSFET has a gate connected to the output terminal of the comparator, a source for connecting to the DC fan, a drain connecting to a supply voltage.

5. The start-up circuit as claimed in claim 4, wherein said supply voltage is 12V.

6. The start-up circuit as claimed in claim 4, wherein the feedback device comprises a a second resistor and a third resistor, and a source of the MOSFET outputs a signal to said other one of the input terminals of the comparator via the second resistor and the third resistor.

7. The start-up circuit as claimed in claim 6, wherein a node between respective ends of the second resistor and the third resistor is connected to said the other one of the input terminals of the comparator, the other end of the second resistor is connected to a node between the source of the MOSFET and the DC fan, the other end of the third resistor is grounded, one end of a second capacitor is connected to the other end of the second resistor, and the other end of the second capacitor is grounded.

8. A start-up circuit comprising:
a direct current (DC) fan;
a digital-analog converter for converting a digital control signal of a control chip to an analog control signal, the digital-analog converter comprising an output terminal;
a comparator comprising two input terminals and an output terminal, one of the input terminals being connected to the output terminal of the digital-analog converter;
a switching device for controlling start-up of the DC fan comprising a first terminal connected to a supply voltage, a second terminal connected to the DC fan, and a third terminal connected to the output terminal of the comparator; and
a feedback device for adjusting a current passing through the switching device, an output signal of the switching device being inputted to the other one of the input terminals of the comparator via the feedback device.

9. The start-up circuit as claimed in claim 8, wherein the digital-analog converter comprises an integral circuit that has a first resistor and a first capacitor connected in series, an input terminal of the first resistor receives the digital control signal of the control chip, an output terminal of the first resistor is connected to one end of the first capacitor and acting as the output terminal of the digital-analog converter, and the other end of the first capacitor is grounded.

10. The start-up circuit as claimed in claim 9, wherein the first capacitor also prevents a large current flow at the instant of power turn-on of the start-up circuit.

11. The start-up circuit as claimed in claim 8, wherein the switching device is a P-channel enhancement mode Metal-Oxide Semiconductor Field Effect Transistor (MOSFET), the first terminal of the switching device is a drain, the second terminal of the switching device is a source, and the third terminal of the switching device is a gate.

12. The start-up circuit as claimed in claim 8, wherein one end of the feedback device is connected to the other one of the input terminals of the comparator, and the other end of the feedback is connected to a node between the second terminal of the switching device and the DC fan.

13. The start-up circuit as claimed in claim 12, wherein the feedback device comprises a second resistor and a third resistor, and the second terminal of the switching device outputs a signal to said other one of the input terminals of the comparator via the second resistor and the third resistor.

14. The start-up circuit as claimed in claim 13, wherein a node between respective ends of the second resistor and the third resistor is connected to the other one of the input terminals of the comparator, the other end of the second resistor is connected to the node between the second terminal of the switching device and the DC fan, the other end of the third resistor is grounded, one end of a second capacitor is connected to the other end of the second resistor, and the other end of the second capacitor is grounded.

15. A circuit assembly comprising:
a functional component;
a power source providing a supply voltage to activate said component;
a switching device electrically connectable between said component and said power source to control transmission of said supply voltage from said power source to said component;
means for generating control signals to control activation of said component;
a voltage stabilizer electrically connectable between said means and said switching device, said stabilizer accepting said control signals from said means and accordingly transmitting said control signals to said switching device to enable switching of said switching device in response to said control signals; and
a feedback device electrically connectable between said component and said stabilizer for adjusting an electrical current passing through said component by means of transmitting said passing electrical current to said stabilizer to adjust a way of said stabilizer transmitting said control signals to said switching device.

16. The circuit assembly as claimed in claim 15, wherein said means generating said control signals is a digital-analog converter for converting digital control signals of a control chip to analog control signals.

17. The circuit assembly as claimed in claim 15, wherein said means comprising a first capacitor to protect said circuit assembly from any large electrical current, and a second capacitor is electrically connectable between said component and said feedback device for filtering said supply voltage transmitted to said component.
